(19) United States
(12) Patent Application Publication
(10) Pub. No.: US 2026/0280611 A1
(43) Pub. Date: Sep. 17, 2026

(54) COMMUNICATIONS VIA TRANSMISSIVE SURFACES USING DIFFERENT BEAMS FOR UPLINK AND DOWNLINK

(71) Applicant: QUALCOMM Incorporated, San Diego, CA (US)

(72) Inventors: Narayan PRASAD, Westfield, NJ (US); Kiran VENUGOPAL, Green Brook, NJ (US); Jorge FABREGA SANCHEZ, San Diego, CA (US); Tao LUO, San Diego, CA (US); Junyi LI, Greentown, PA (US); Allen Minh-Triet TRAN, Rancho Santa Fe, CA (US)

(21) Appl. No.: 19/080,612

(22) Filed: Mar. 14, 2025

(51) Int. Cl. H04B 7/04; H04B 7/0408; H04W 16/28; H04W 88/04

(52) U.S. Cl. CPC H04B 7/04013; H04B 7/0408; H04W 16/28; H04W 88/04

(57) ABSTRACT

Methods, systems, and devices for wireless communications are described. Structures such as buildings or vehicles may include transmissive surfaces (TSs) on glass surfaces that allow penetration of radio frequency signals through the glass surface. A user equipment (UE) within such a structure may communicate with a network entity outside of the structure via beams that are refracted through such TSs. In some examples, different TSs, and thus different sets of beams, may be used for uplink and downlink communications involving a UE and a network entity. Accordingly, a UE may receive downlink messages via a first set of beams and a first TS and may transmit uplink messages via a second set of beams and a second TS. In some examples, such decoupling of uplink and downlink beams in association with the use of different TSs may be based on satisfaction of a triggering condition.

### FIELD OF TECHNOLOGY

The following relates to wireless communications, including communications via transmissive surfaces using different beams for uplink and downlink.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include communicating, with a network entity, control signaling associated with downlink beamforming via a first transmissive surface (TS) between the UE and the network entity, where the control signaling is further associated with uplink beamforming via a second TS between the UE and the network entity, receiving, via a first set of beams associated with the first TS, one or more downlink messages based on the control signaling, and transmitting, via a second set of beams associated with the second TS, one or more uplink messages based on the control signaling, where the first set of beams are different from the second set of beams, and where the first TS is different from the second TS.

A UE for wireless communications is described. The UE may include one or more memories storing processor executable code, and one or more processors coupled with the one or more memories. The one or more processors may individually or collectively be operable to execute the code to cause the UE to communicate, with a network entity, control signaling associated with downlink beamforming via a first TS between the UE and the network entity, where the control signaling is further associated with uplink beamforming via a second TS between the UE and the network entity, receive, via a first set of beams associated with the first TS, one or more downlink messages based on the control signaling, and transmit, via a second set of beams associated with the second TS, one or more uplink messages based on the control signaling, where the first set of beams are different from the second set of beams, and where the first TS is different from the second TS.

Another UE for wireless communications is described. The UE may include means for communicating, with a network entity, control signaling associated with downlink beamforming via a first TS between the UE and the network entity, where the control signaling is further associated with uplink beamforming via a second TS between the UE and the network entity, means for receiving, via a first set of beams associated with the first TS, one or more downlink messages based on the control signaling, and means for transmitting, via a second set of beams associated with the second TS, one or more uplink messages based on the control signaling, where the first set of beams are different from the second set of beams, and where the first TS is different from the second TS.

A non-transitory computer-readable medium storing code for wireless communications is described. The code may include instructions executable by one or more processors to communicate, with a network entity, control signaling associated with downlink beamforming via a first TS between the UE and the network entity, where the control signaling is further associated with uplink beamforming via a second TS between the UE and the network entity, receive, via a first set of beams associated with the first TS, one or more downlink messages based on the control signaling, and transmit, via a second set of beams associated with the second TS, one or more uplink messages based on the control signaling, where the first set of beams are different from the second set of beams, and where the first TS is different from the second TS.

In some examples of the method, UEs, and non-transitory computer-readable medium described herein, communicating the control signaling may include operations, features, means, or instructions for receiving, from the network entity, a first control message that indicates a triggering condition associated with communication using different sets of beams for uplink and downlink that may be associated with different TSs between the UE and the network entity and transmitting, to the network entity, a second control message that indicates satisfaction of the triggering condition, where reception of the one or more downlink messages via the first set of beams and transmission of the one or more uplink messages via the second set of beams may be based on the second control message.

Some examples of the method, UEs, and non-transitory computer-readable medium described herein may further include operations, features, means, or instructions for receiving a set of synchronization signal blocks (SSBs) via the first TS and the second TS, and where the satisfaction of the triggering condition may be based on reception of the set of SSBs.

In some examples of the method, UEs, and non-transitory computer-readable medium described herein, receiving the set of SSBs may include operations, features, means, or instructions for receiving a first subset of the set of SSBs via a first receive beam associated with the first TS and receiving a second subset of the set of SSBs via a second receive beam associated with the second TS.

In some examples of the method, UEs, and non-transitory computer-readable medium described herein, receiving the set of SSBs may include operations, features, means, or instructions for receiving each of the set of SSBs via a first receive beam associated with the first TS and receiving each of the set of SSBs via a second receive beam associated with the second TS.

In some examples of the method, UEs, and non-transitory computer-readable medium described herein, the satisfaction of the triggering condition includes a first SSB of the set of SSBs received via the first TS and a second SSB of the set of SSBs received via the second TS each exceeding a threshold measurement value.

In some examples of the method, UEs, and non-transitory computer-readable medium described herein, the triggering condition includes positioning information of the UE within a building or vehicle that includes the first TS and the second TS.

Some examples of the method, UEs, and non-transitory computer-readable medium described herein may further include operations, features, means, or instructions for receiving, based on the second control message, a first set of channel state information (CSI) reference signals (CSI-RSs) via the first TS and receiving, based on the second control message, a second set of CSI-RSs via the second TS, and where communicating the control signaling includes transmitting one or more CSI reports based on the first set of CSI-RSs and the second set of CSI-RSs, where the first set of beams and the second set of beams may be based on the one or more CSI reports.

In some examples of the method, UEs, and non-transitory computer-readable medium described herein, the one or more CSI reports indicate a first selection of a downlink resource set based on the first set of CSI-RSs, the first set of beams may be based on the first selection of the downlink resource set, the one or more CSI reports indicate a second selection of an uplink resource set based on the second set of CSI-RSs, and the second set of beams may be based on the second selection of the uplink resource set.

In some examples of the method, UEs, and non-transitory computer-readable medium described herein, communicating the control signaling may include operations, features, means, or instructions for receiving, from the network entity and based on the one or more CSI reports, a third control message that schedules a set of sounding reference signals (SRSs), transmitting, in accordance with the third control message, the set of SRSs, and receiving, from the network entity and based on the set of SRSs, an indication of the second set of beams.

In some examples of the method, UEs, and non-transitory computer-readable medium described herein, communicating the control signaling may include operations, features, means, or instructions for receiving, from the network entity and based on the one or more CSI reports, a third control message that requests one or more uplink transmission metrics, transmitting, to the network entity, a fourth control message that indicates the one or more uplink transmission metrics, and receiving, from the network entity and based on the fourth control message, an indication of the second set of beams.

Some examples of the method, UEs, and non-transitory computer-readable medium described herein may further include operations, features, means, or instructions for receiving, from the network entity and based on the one or more CSI reports, a third control message that indicates one or more uplink transmission power or path loss offset metrics, where the one or more uplink messages may be transmitted in accordance with the one or more uplink transmission power or path loss offset metrics.

In some examples of the method, UEs, and non-transitory computer-readable medium described herein, a first relative positioning between the UE and the first TS; a second relative positioning between the UE and the second TS; a third relative positioning between the network entity and the first TS, where the first set of CSI-RSs and the second set of CSI-RSs may be received via the network entity; a fourth relative positioning between the network entity and the second TS; geometric information of the first TS; geometric information of the second TS; or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports communications via transmissive surfaces (TSs) using different beams for uplink and downlink in accordance with one or more aspects of the present disclosure.

FIG. 2 shows an example of a TS signaling diagram that supports communications via TSs using different beams for uplink and downlink in accordance with one or more aspects of the present disclosure.

FIG. 3 shows an example of a TS signaling diagram that supports communications via TSs using different beams for uplink and downlink in accordance with one or more aspects of the present disclosure.

FIG. 4 shows an example of a wireless communications system that supports communications via TSs using different beams for uplink and downlink in accordance with one or more aspects of the present disclosure.

FIG. 5 shows an example of a TS orientation diagram that supports communications via TSs using different beams for uplink and downlink in accordance with one or more aspects of the present disclosure.

FIG. 6 shows an example of a process flow that supports communications via TSs using different beams for uplink and downlink in accordance with one or more aspects of the present disclosure.

FIGS. 7 and 8 show block diagrams of devices that support communications via TSs using different beams for uplink and downlink in accordance with one or more aspects of the present disclosure.

FIG. 9 shows a block diagram of a communications manager that supports communications via TSs using different beams for uplink and downlink in accordance with one or more aspects of the present disclosure.

FIG. 10 shows a diagram of a system including a device that supports communications via TSs using different beams for uplink and downlink in accordance with one or more aspects of the present disclosure.

FIG. 11 shows a flowchart illustrating methods that support communications via TSs using different beams for uplink and downlink in accordance with one or more aspects of the present disclosure.

### DETAILED DESCRIPTION

An energy-attenuating glass may improve an energy efficiency of an associated space, such as a vehicle or structure. For example, the energy-attenuating glass may include one or multiple layers of metal that provide an energy-attenuating coating, such as one or more layers of silver, tin, or zinc. The energy-attenuating coating may permit visible light to pass through, but may deflect ultraviolet rays, infrared light, or both. Deflecting the ultraviolet rays and infrared light may reduce heat loss within the space (e.g., the vehicle or structure). However, the energy-attenuating glass, such as energy-attenuating construction glass, may prevent a radio frequency (RF) signal from penetrating the structure. For example, energy-attenuating construction glass may prevent RF signals from penetrating inside or outside of structures due to (e.g., based on) a presence of the layer(s) of metal on the glass surface. In other words, a glass substrate may include the layer(s) of metal, such as the energy-attenuating coating. In some examples, a penetration of RF signals through the energy-attenuating glass may improve by implementing a cut-out pattern on a portion of the energy-attenuating coating. For example, a portion of the energy-attenuating coating may be etched (e.g., with a laser) to include the cut-out pattern, where the etched portion may allow the RF signal to pass through. In some examples, a vehicle or structure may include multiple such cut-outs, which may be referred to as transmissive surfaces (TSs). A user equipment (UE) within such a space (e.g., within a vehicle, building, or other structure) may communicate with a network entity outside of the space via beams that are refracted through such TSs. Different TSs may operate better for different ranks (e.g., quantities of transmission layers), for example, based on the layout of the TSs and/or the antenna configurations of the network entity and the UE.

In some examples, different TSs, and thus different sets of beams, may be used for uplink and downlink communications involving a UE. For example, a UE may use fewer spatial layers for uplink communications than downlink communications. Accordingly, a UE may receive downlink messages via a first set of beams and a first TS and may transmit uplink messages via a second set of beams and a second TS. In some examples, such decoupling of uplink and downlink beams in association with the use of different TSs may be based on satisfaction of a triggering condition. For example, the triggering condition may be when synchronization signal blocks (SSBs) (which could be the same SSB) received via multiple receive beams at the UE satisfy a reference signal received power (RSRP) threshold, which may indicate that multiple distinct paths may be used for uplink and downlink. For example, the same SSB (e.g., the same indexed SSB) received via the two different TSs satisfying the RSRP threshold via both TSs may satisfy the triggering condition. For example, the SSB may be a wide SSB. As another example, two different indexed SSBs received via the two different TSs satisfying the RSRP threshold may satisfy the triggering condition. As another example, the triggering condition may be that the UE is positioned within a space (such as a building or vehicle) that includes the multiple different TSs. After the triggering condition is satisfied, the UE and the network entity may perform beam training to select the first set of beams for downlink and the second set of beams for uplink. For example, based on selected SSBs, the network entity may transmit a first set of channel state information (CSI) reference signals (CSI-RSs) associated with a first TS (e.g., which the UE may receive via the first TS) and a second set of CSI-RSs associated with a second TS (e.g., which the UE may receive via the second TS). In some examples, as communication via the TSs may be near-field communication, the spherical curvature of the wave may be considered when designing CSI-RSs. Accordingly, the distances between the network entity and the TSs and/or the TSs and the UEs may be accounted for when selecting the CSI-RSs. The UE may perform measurements on the CSI-RSs, and the first set of beams for downlink and the second set of beams for uplink may be selected based on the measurements of the CSI-RSs.

Particular aspects of the subject matter described in this disclosure can be implemented to realize one or more of the following potential advantages. By using different sets of beams for uplink and downlink, the network entity and the UE may use different TSs in scenarios where a UE is located indoors. Different TSs may be beneficial for different ranks based on the layout of the TSs. For example, a TS that is beneficial for rank-2 may be used for downlink transmissions involving two spatial layers, and a different TS that is beneficial for rank-1 may be used for uplink transmissions involving a single spatial layer. Accordingly, throughput of uplink and downlink communications may be increased by decoupling the sets of beams used for uplink and downlink transmissions based on which beams are used for communications via which TSs. As another example, different TSs may be beneficial based on the antenna configurations of the network entity and the UE. For example, if the UE uses one antenna array for reception and another for transmission, one TS may be more beneficial for reception of downlink and another TS may be more beneficial for transmission of uplink signals. Accordingly, aspects of the subject matter described herein may enable use of the TS that is most beneficial for each communication direction, thereby increasing throughput.

Aspects of the disclosure are initially described in the context of wireless communications systems. Aspects of the disclosure are further illustrated by and described with reference to TS signaling diagrams TS orientation diagrams, process flows, apparatus diagrams, system diagrams, and flowcharts that relate to communications via TSs using different beams for uplink and downlink.

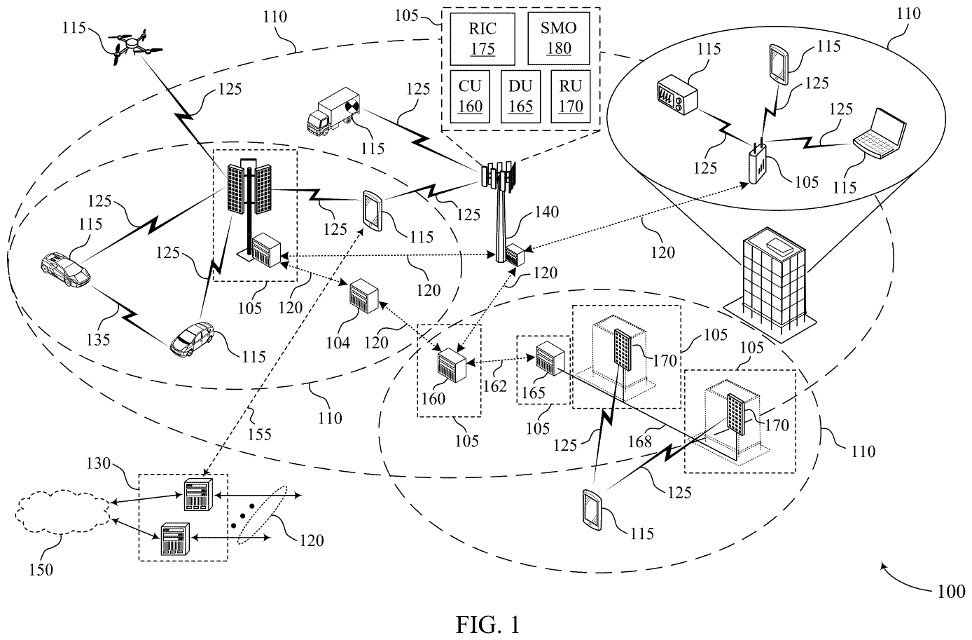

FIG. 1 shows an example of a wireless communications system 100 that supports communications via TSs using different beams for uplink and downlink in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., an RF access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support communications via TSs using different beams for uplink and downlink as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 MHz to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Penetration loss may be a limiting factor (especially for high-frequency mmWave and beyond communications) which may restrict indoor cell coverage (e.g., cell coverage for a UE 115 within a structure). For example, buildings may include materials such as concrete and energy-attenuating glass. A structure may include energy attenuating glass to improve the energy efficiency of the space (e.g., with respect to heating or cooling). Signals transmitted from an outdoor network entity 105 (such as a gNB or a TRP) may be significantly weakened by transmission through such building materials. Thus, UEs 115 located indoors may have poor cell signal quality, which may restrict communications to single-layer communications, which may lose the spectral efficiency provided by multi-layer communications. Automobiles and trains may similarly include energy-attenuating glass, and accordingly UEs 115 located within vehicles may suffer similar poor cell coverage. Intelligent surfaces may be used as a transmissive/refracting surface to improve coverage for UEs 115 located in structures or vehicles. Intelligent surfaces that are not passive may be dynamically reconfigured to redirect and pass through incident radiation. Such reconfigurability, however, may demand tunable electronic components and a power supply, which may involve non-negligible costs. In some examples, penetration loss may be reduced via treating a portion of a glass surface to reduce the penetration loss. For example, the portion of glass may be etched (e.g., with a laser) to include a cut-out pattern, where the etched portion may allow the RF signal to pass through. For example, TSs may be designed and placed on glass surfaces to achieve multi-layer (per-polarization) communications in out-to-in and in-to-out scenarios. An out-to-in scenario may refer to a communication from an outside network entity 105 to a UE 115 within a structure or vehicle. An in-to-out scenario may refer to a communication from a UE 115 within a structure or vehicle to an outside network entity 105.

The presence of engineered TSs on glass surfaces designed for anomalous refraction may create scenarios in which decoupled uplink and downlink operation may be implemented. For example, the network entity 105 may use separate beams for receiving in uplink and transmitting in downlink. To facilitate such decoupled uplink and downlink, control signaling between a UE 115 and a network entity may be implemented that triggers beam training for the decoupled uplink and downlink beams. For example, configurable signaling may be exchanged between the UE 115 and the network entity to allow for an indication from the UE 115 to the network entity 105 of whether decoupled uplink and downlink operation is likely to be beneficial. In some examples, when the UE 115 provides such an indication, the network entity 105 may transmit a multi-port CSI-RS resource set with repetition, which the UE 115 may measure and report to the network entity 105. For example, the UE 115 may receive a first set of the CSI-RSs via a first TS associated with a first beam or set of beams, and the UE 115 may receive a second set of the CSI-RSs via a second TS associated with a second beam or set of beams. Transmission of such multi-port CSI-RSs based on the indication from the UE 115 may reduce power consumption and wastage of transmission resources associated with such multi-port CSI-RSs in scenarios where decoupled uplink and downlink is not likely to be beneficial for spectral efficiency. In some examples, the network entity 105 and the UE 115 may indicate or exchange parameters such as distances to the TSs, dimensions of the TSs, or reference points, which may enable the network entity 105 to employ configurable beams to beamform based on such parameters and the UE 115 to receive the multi-port CSI-RS resource set.

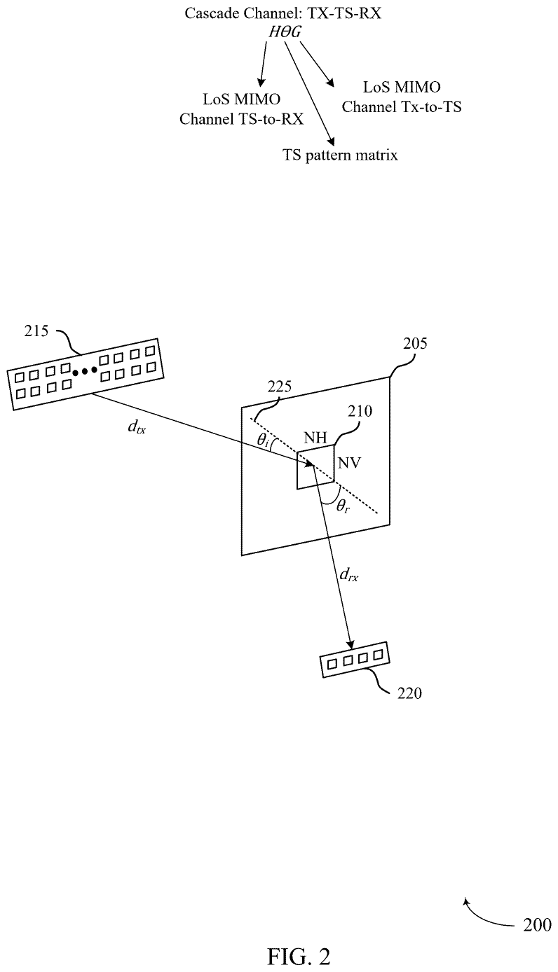

FIG. 2 shows an example of a TS signaling diagram 200 that supports communications via TSs using different beams for uplink and downlink in accordance with one or more aspects of the present disclosure. The TS signaling diagram 200 may implement or may be implemented by aspects of the wireless communications system 100.

The TS signaling diagram 200 includes a glass surface 205 that includes a TS 210. The TS signaling diagram 200 includes transmitting antenna array 215 and a receiving antenna array 220. A TS 210 may include multiple unit cells spaced apart from each other (e.g., spaced at 3 millimeters (mm)). Each unit cell may be assigned one set of 20 phase-values within a span of 130 degrees. The TS 210 may have a layout of a number of horizontal (NH) unit cells and a number of vertical (NV) unit cells, and a total quantity of unit cells may be NH×NV. Multiple TS layouts may be used or considered. For example, a rectangular NH=360 unit-cells×NV=40 unit-cells layout may be used (e.g., a 360×40 layout), a rectangular NH=40 unit-cells×NV=360 unit-cells layout may be used (e.g., a 40×360 layout), and a square NH=120 unit-cells×NV=120 unit-cells layout may be used (e.g., a 120×120 layout). The line 225 shows a line perpendicular to the TS 210 (e.g., the line 225 shows the boresight of the TS 210).

The transmitting antenna array 215 may have a quantity of vertical antenna elements and a quantity of horizonal antenna elements (e.g., the transmitting antenna array 215 may be a 16×4 or 4×16 uniform planar array (UPA)) and the receiving antenna array 220 may have a quantity of vertical antenna elements and a quantity of horizonal antenna elements (e.g., the receiving antenna array 220 may be a 1×4 or a 4×1 uniform linear array (ULA)). In some examples, the spacing of the antenna elements of the transmitting antenna array 215 and the receiving antenna array 220 may be a 2/2 spacing at 28 GHz. The distance between the transmitting antenna array 215 and the TS 210 may be referred to as dux, and distance between the receiving antenna array 220 and the TS 210 may be referred to as dᵣₓ. The angle θᵢ shows the incident angle (e.g., an angle between the line 225 and a most direct line between the TS 210 and the transmitting antenna array 215). The angle θᵣ shows the refraction angle (e.g., an angle between the line 225 and a most direct line between the TS 210 and the receiving antenna array 220).

A signal transmitted from the transmitting antenna array 215 to the receiving antenna array 220 via the TS 210 may experience a cascade channel, which may be referred to as TX-TS-RX, and may be given by HOG as shown in FIG. 2. Assuming line of sight (LoS) dominant channels, H may be a LOS MIMO channel from the TS 210 to the receiving antenna array 220, θ may be the TS pattern matrix, and G may be a LOS MIMO channel from the transmitting antenna array 215 to the TS 210. Assuming LoS dominant channels, G may be given by equation 1, H may be given by equation 2, and θ may be given by equation 3. In equation 1, G_{n,m}, r_{n,m} may be the (coefficient, distance) between m^{th} TX element and n^{th} TS element. In equation 2, H_{p,n}, T_{p,n} may be the (coefficient, distance) between p^{th} RX element and n^{th} TS element. In equation 3, In equations 1, 2, and 3, F_{TS,n,m} may be the element radiation pattern of a TS element evaluated along direction between n^{th} TS element and m^{th} TX element (others are similarly defined). In equation 3, S_{2,1,n} may be a transmission coefficient configured for the n^{th} TS element. In equations 1, 2, and 3, k=2π/λ. In equations 1, 2, and 3, dₓd_{y} may be the area of a TS unit cell.

$$G = [ {G}_{n , m} ] : {G}_{n , m} = \frac{\sqrt{{d}_{x} {d}_{y} {F}_{TX , m , n} {F}_{TS , n , m}} {e}^{- {jkr}_{n , m}}}{2 \sqrt{π} {r}_{n , m}} \qquad ( 1 )$$

$$H = [ {H}_{p , n} ] : {H}_{p , n} = \frac{\sqrt{{d}_{x} {d}_{y} {F}_{RX , p , n} {F}_{TS , p , n}} {e}^{- {jkr}_{p , n}}}{2 \sqrt{π} {r}_{p , n}} \qquad ( 2 )$$

$$Θ = diag \{ {S}_{2 , 1 , 1} , … , {S}_{2 , 1 , N} \} \qquad ( 3 )$$

An optimization for the cascade channel TX-TS-RX may be given by max_{θ}log|1+ρ(HθG)(HθG)*| under the constraint θ=diag{S_{2,1,1}, . . . , S_{2,1,N}}:S_{2,1,n}∈A; |S_{2,1,n}|=1∀n where A is a finite phase alphabet. TS pattern schemes may be tested for different scenarios (including non-paraxial), in which a TS pattern may be assigned to be the beam-focusing solution that considers a virtual source at the center of the transmitting antenna array 215 to a virtual receiver at the center of the receiving antenna array 220 in order to evaluate the impact of the finite phase alphabet and the TS layout. At 28 GHz, testing showed the resulting phase degrees for the center patch sizes of the unit cells of the TS as shown in Table 1. The testing in table 1 assumed identical amplitudes for tested signals.

TABLE 1

| D (center | |
|---|---|
| patch size | Phase |
| in mm) | (degrees) |
| 0 | 54.9 |
| 0.2 | 54.7 |
| 0.4 | 54 |
| 0.6 | 52.3 |
| 0.7 | 51.2 |
| 0.8 | 49.1 |
| 0.9 | 47.7 |
| 1 | 45.3 |
| 1.1 | 42.4 |
| 1.2 | 38.4 |
| 1.3 | 32.3 |
| 1.4 | 24.5 |
| 1.5 | 13.2 |
| 1.6 | −1.8 |
| 1.7 | −18.4 |
| 1.8 | −35 |
| 1.9 | −48.3 |
| 2 | −58.5 |

For a 360×40 TS 210, with a transmitting antenna array 215 configured as a 16×4 UPA, a receiving antenna array 220 configured as a 4×1 ULA, with both antenna arrays having λ/2 spacing at 28 GHz, where dₜₓ=60 meters (m) and dᵣₓ=4 m, using a 400 MHz bandwidth: Table 2 shows a spectral efficiency (in bits per second per Hertz) of a first case and Table 3 shows a spectral efficiency of a second case. In case 1, the incident angle θᵢ and refract angle θᵣ are along the boresight (e.g., θᵢ=0 and θᵣ=0). In case 2, the incident angle θᵢ is normal and the refract angle θᵣ is an oblique direction (e.g., θᵢ=0 and θᵣ=20).

TABLE 2

| | | |
|---|---|---|
| Upper bound | 20.3826 | 27.5366 |
| Ideal phase | 20.3809 | 27.534 |
| Practical phase | 17.2212 | 21.6049 |
| Uniform phase | 14.0196 | 13.6312 |

TABLE 3

| | | |
|---|---|---|
| Upper bound | 20.1027 | 26.5165 |
| Ideal phase | 20.0986 | 26.5073 |
| Practical phase | 17.2097 | 20.8281 |
| Uniform phase | 5.5403 | 4.6335 |

For a 120×120 TS 210, with a transmitting antenna array 215 configured as a 16×4 UPA, a receiving antenna array 220 configured as a 4×1 ULA, with both antenna arrays having λ/2 spacing at 28 GHz, where dₜₓ=60 m and dᵣₓ=4 m, using a 400 MHz bandwidth: Table 4 shows a spectral efficiency of a first case and Table 5 shows a spectral efficiency of a second case. In case 1, the incident angle θᵢ and refract angle θᵣ are along the boresight (e.g., θᵢ=0 and θᵣ=0). In case 2, the incident angle θᵢ is normal and the refract angle θᵣ is an oblique direction (e.g., θᵢ=0 and θᵣ=20).

TABLE 4

| | | |
|---|---|---|
| Upper bound | 20.4948 | 21.7755 |
| Ideal phase | 20.4948 | 21.7754 |
| Practical phase | 18.1089 | 18.1097 |
| Uniform phase | 17.1253 | 16.6388 |

TABLE 5

| | | |
|---|---|---|
| Upper bound | 20.1804 | 20.8720 |
| Ideal phase | 20.1801 | 20.8712 |
| Practical phase | 17.2791 | 16.6592 |
| Uniform phase | 5.3036 | 4.3638 |

For a 40×360 TS 210, with a transmitting antenna array 215 configured as a 16×4 UPA, a receiving antenna array 220 configured as a 4×1 ULA, with both antenna arrays having λ/2 spacing at 28 GHz, where dₜₓ=60 m and dᵣₓ=4 m, using a 400 MHz bandwidth: Table 6 shows a spectral efficiency of a first case and Table 6 shows a spectral efficiency of a second case. In case 1, the incident angle θᵢ and refract angle θᵣ are along the boresight (e.g., θᵢ=0 and θᵣ=0). In case 2, the incident angle θᵢ is normal and the refract angle θᵣ is an oblique direction (e.g., θᵢ=0 and θᵣ=20).

TABLE 6

| | | |
|---|---|---|
| Upper bound | 20.4920 | 19.7856 |
| Ideal phase | 20.4920 | 19.5587 |
| Practical phase | 17.3397 | 16.3479 |
| Uniform phase | 14.0243 | 13.0251 |

TABLE 7

| | | |
|---|---|---|
| Upper bound | 20.1752 | 19.3537 |
| Ideal phase | 20.1751 | 19.2140 |
| Practical phase | 17.2264 | 16.2313 |
| Uniform phase | 6.8684 | 5.8808 |

As shown in the examples, assigning a TS pattern to be the beam-focusing solution that considers a virtual source at the center of the transmitting antenna array 215 to a virtual receiver at the center of the receiving antenna array 220 may be close to optimal. The layout of the TS 210 may be relevant to enable rank and throughput gains. The achieved gains may depend of the transmit and receive antenna configurations relative to the TS configuration. One TS layout may achieve better throughput at lower ranks while another may achieve higher throughput via higher ranks. Uniform patterns may not achieve throughput gains, but beam focusing based designs may achieve such gains.

Observations have also been made with respect to the three TS layouts (360×40, 40×306, and 120×120) where the transmitting antenna array 215 is a 16×4 UPA array, the receiving antenna array 220 is a 1×4 ULA, with both antenna arrays having λ/2 spacing at 28 GHz, where dₜₓ=40 m and dᵣₓ=4 m, using a 400 MHz bandwidth, and an equivalent isotropic radiated power (EIRP) of 37 dBm, with θᵢ=0 (e.g., along the boresight) and three refraction angles θᵣ (0, 20, and 40 degrees). One such observation is that a rectangular TS with NH=360 and NV=40 may be best suited and may result in significant downlink throughput improvement compared to the other two layouts. Another such observation may be that a beam-focusing based TS pattern is better for throughput than either specular or broadening pattern (e.g., over 2× improvement). The 360×40 TS layout may result in noticeable rank improvement (with rank-2 improvement being over 35% better than rank-1 throughput), while the 40×360 and 120×120 layouts may not achieve such rank improvements. The 120-×120 layout may result in the best rank-1 performance among the three observed TS layouts. Analogous observations have been made for scenarios where the transmitting antenna array 215 is a 4×16 UPA array and the receiving antenna array 220 is a 1×4 ULA, in which case the 40×360 TS layout becomes the best TS layout among the three layouts for downlink throughput while the 120×120 remains the best TS layout for rank-1 among the three layouts. Accordingly, as observed, different TS layouts may achieve better performance depending on the rank and the layouts of the transmitting and receiving antenna arrays.

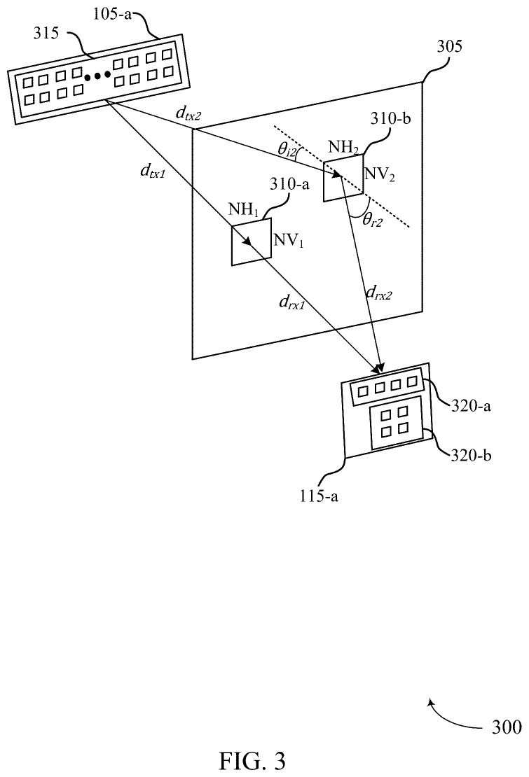

FIG. 3 shows an example of a TS signaling diagram 300 that supports communications via TSs using different beams for uplink and downlink in accordance with one or more aspects of the present disclosure. The TS signaling diagram 300 may implement or may be implemented by aspects of the wireless communications system 100 or the TS signaling diagram 200.

The TS signaling diagram 300 includes a glass surface 305 that includes a first TS 310-a and a second TS 310-b. Each TS 310 may include multiple unit cells spaced apart from each other (e.g., spaced at 3 millimeters (mm)). Each unit cell may be assigned one set of 20 phase-values within a span of 130 degrees. The first TS 310-a may have a layout of NH₁ and NV₁, and the second TS 310-b may have a layout of NH₂ and NV₂. For example, the first TS 310-a may be a 120×120 TS (e.g., NH₁=120 and NV₁=120), and the second TS 310-b may be a 360×40 TS (e.g., NH₂=360 and NV₂=40).

A network entity 105-a, which may be an example of a network entity 105 as described herein, may include an antenna array 315. The antenna array 315 may have a quantity of vertical antenna elements and a quantity of horizonal antenna elements (e.g., the antenna array 315 may be a 16×4 or 4×16 UPA). A UE 115-a, which may be an example of a UE 115 as described herein, may include one or more antenna arrays 320. For example, in some scenarios the UE 115-a may have a single antenna array (e.g., the antenna array 320-a which may be a 4×1 ULA).

The distance between the first TS 310-a and the network entity 105-a may be given by dₜₓ₁, and the distance between the first TS 310-a and the UE 115-a may be given by dᵣₓ₁. The distance between the second TS 310-b and the network entity 105-a may be given by dₜₓ₂, and the distance between the second TS 310-b and the UE 115-a may be given by dᵣₓ₂. The incident and refract angles for the first TS 310-a with respect to the UE 115-a and the network entity 105-a may be along the boresight (e.g., θᵢ₁=0 and θᵣ₁=0). The incident and refract angles for the second TS 310-b with respect to the UE 115-a and the network entity 105-a may be oblique (e.g., θᵢ₂=20 degrees and θᵣ₂=20 degrees).

In some examples, dₜₓ₁=40 m, dᵣₓ₁=4 m, a 400 MHz bandwidth may be used, and a practical phase-only alphabet may be used for the TSs 310. In such examples, the second TS 310-b may provide a better downlink channel using rank-2 transmission/reception than the first TS 310-a, and thus the second TS 310-b may yield a higher downlink throughput than the first TS 310-a. In such examples, the first TS 310-a may provide a better uplink channel using rank-1 transmission/reception than the second TS 310-b, and thus the first TS 310-a may yield a higher uplink throughput. Using the first TS 310-a for uplink and the second TS 310-b for downlink may yield at least a 10% rate improvement for both uplink and downlink as compared to use of a single TS. Such decoupled use of different TSs for uplink and downlink may involve separate beams for transmission and reception by the network entity 105-a (e.g., the receive beam for the network entity 105-a may be different, from either of the two downlink transmit beams (where downlink rank-2 is used). For example, the main lobes of the transmit and receive beams may point to directions that can be significantly different, or more generally can have a significantly different beamforming gain profile versus spatial directions). Similarly, the UE 115-a may use separate beams for transmission and reception, each aligned to a separate TS for communicating with the network entity 105-a.

In some examples, the UE 115-a may include multiple antenna arrays 320. For example, the UE 115-a may include an antenna array 320-a (e.g., the 4×1 ULA with an EIRP of 21 dBm) and an antenna array 320-b (e.g., a 2×2 UPA with an EIRP of 24 dBm), and both antenna arrays 320 may use a λ/2 spacing at 28 GHz. In such cases, using rank-2 communications via the second TS 310-b may yield the higher downlink throughput than the first TS 310-a (e.g., the network entity 105-a to second TS 310-b to UE 115-a channel may have a better effective rank and the network entity 105-a may use a higher transmission power). In such cases, using rank-1 communications via the first TS 310-a may yield a higher uplink throughput than using the second TS 310-b (e.g., the UE 115-a to first TS 310-a to network entity 105-a channel may have a stronger dominant singular value and the UE 115-a may use a lower transmission power with the antenna array 320-b having lower loss). Using the first TS 310-a for uplink and the second TS 310-b for downlink may yield a 20% rate improvement for both uplink and downlink as compared to use of a single TS.

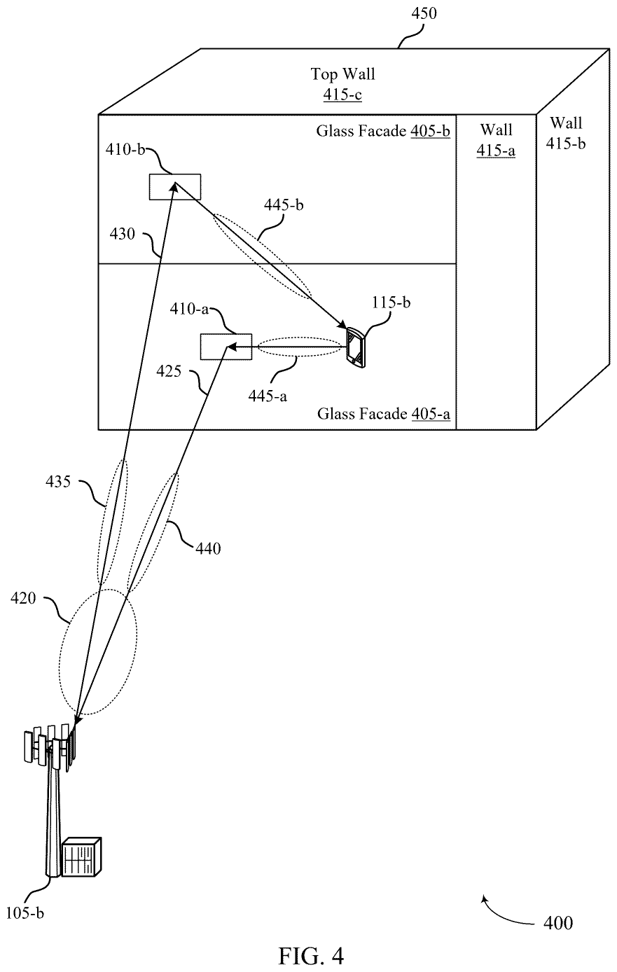

FIG. 4 shows an example of a wireless communications system 400 that supports communications via TSs using different beams for uplink and downlink in accordance with one or more aspects of the present disclosure. The wireless communications system 400 may implement or may be implemented by aspects of the wireless communications system 100, the TS signaling diagram 200, or the TS signaling diagram 300. For example, the wireless communications system 400 may include a UE 115-b, which may be an example of a UE 115 as described herein. The wireless communications system 400 may include a network entity 105-b, which may be an example of a network entity 105 as described herein.

The UE 115-b may be located within a structure 450 (e.g., a building or a vehicle) which includes one or more glass facades 405 (e.g., a glass facade 405-a and a glass facade 405-b). The structure may include solid side walls 415 (e.g., a brick wall, a concrete wall, a metal wall). The glass facades 405 may include TSs 410. For example, the glass facade 405-a may include a TS 410-a, and the glass facade 405-b may include a TS 410-b. For example, where the structure 450 is a building and the UE 115-b is located inside the building, the glass facades 405 may be windows on a side of the building, and the solid walls 415 may be internal or external walls of the building. For example, the solid wall 415-a and the solid wall 415-b may be interior and exterior vertical walls of the building, and the solid wall 415-c may be the ceiling of a floor of the building or a roof of the building. As another example, where the structure 450 is a vehicle, the glass facades 405 may be windows of the vehicle, such as a windshield, side windows, or rear windows. Similarly, where the structure 450 is a vehicle, the solid wall 415-a and the solid wall 415-b may be solid exterior components of the vehicle (e.g., metal doors, trunks, and/or hoods), and the solid wall 415-c may be a roof of the vehicle.

As described herein, different TSs 410 may be advantageous for communicating different quantities of layers (e.g., depending on the TS cell patterns, the TS layouts, the antenna configuration of the UE 115-b, the antenna configuration of the network entity 105-b, and/or the power budgets of the TSs 410). For example, one TS 410 may be better for uplink signaling 425 (e.g., transmission from the UE 115-b to the network entity 105-b) and another TS 410 may be better for downlink signaling 430 (e.g., transmission from the network entity 105-b to the UE 115-b), and the respective underlying beams may be distinct without mutual beam correspondence relation, where the mutual beam correspondence relation restricts the beams to be similar (e.g., have their pointing directions to be same or sufficiently close).

In some examples, the UE 115-b and the network entity 105-b may implement control or configuration signaling that enables the network entity 105-b to select a separate TS 410 for uplink signaling 425 and downlink signaling 430. For example, the UE 115-b may receive downlink signaling 430 substantially via the TS 410-b (with small contribution from other TSs 410), and the network entity 105-b may receive uplink signaling 425 substantially via the TS 410-a (with small contribution from other TSs 410). In some examples, such control or configuration signaling may include triggering conditions, which may involve transmission of reference signals to enable the selection of separate beams (e.g., one or more beams 435 (and 445-b) for downlink signaling 430 and one or more beams 440 (and 445-a) for uplink signaling 425) when the triggering condition is satisfied. For example, resources for transmission of reference signals and the associated signaling to establish the decoupling of TSs for uplink and downlink may be provisioned for reporting when the triggering condition occurs, and such provisioned control or configuration signaling may be light-weight (e.g., may involve relatively small quantities of resources and may be configured in an on-demand manner).

In some examples, the network entity 105-b may transmit one or more SSBs 420. The phase profiles of the TS 410-a and the TS 410-b may be selected based on beamfocusing, and thus may enable multi-rank for the UE 115-b at some locations of the UE 115-b within the structure 450.

In some examples, the network entity 105-b may configure the UE 115-b to send an indication of a triggering condition that indicates separate uplink/downlink beams (and thus decoupled TSs 410 for uplink signaling 425 and downlink signaling 430) may be beneficial. For example, the UE 115-b may receive the one or more SSBs 420 via multiple beams 445 associated with the different TSs 410 (e.g., a beam 445-a associated with the TS 410-a and a beam 445-b associated with the TS 410-b). Based on measurements of the one or more SSBs 420, the UE 115-b may determine that separate uplink/downlink beams would be beneficial, and may send a message to the network entity 105-b that indicates the triggering condition is satisfied. Based on the message that indicates that the triggering condition is satisfied, the network entity 105-b may send a first set of CSI-RSs via the one or more beams 440 (e.g., via a first multi-port CSI-RS resource set with repetition) for reception via the TS 410-a and a second set of CSI-RSs via the one or more beams 435 (e.g., via a second multi-port CSI-RS resource set with repetition) for reception via the TS 410-b. The UE 115-b may report the preferred downlink resource set (e.g., in a CSI report) based on the set of CSI-RSs received via the TS 410-b associated with downlink transmission. The UE 115-b may report the preferred uplink resource set based on the set of CSI-RSs received via the TS 410-a associated with uplink transmission. For example, the TS 410-b may be used for rank-2 downlink communications, and accordingly a CSI report may indicate two selected or preferred CSI-RS resources from the second set of CSI-RSs, which may be used for downlink signaling 430. The TS 410-a may be used for rank-1 uplink communication, and accordingly a CSI report may indicate a selected or preferred CSI-RS resource from the first set of CSI-RSs. In some examples, the CSI report may indicate metrics for the first set of CSI-RSs, and the network entity 105-b may select an uplink beam based on the indicated metrics. In some such examples, the network entity 105-b may indicate the selected uplink beam to the UE 115-b.

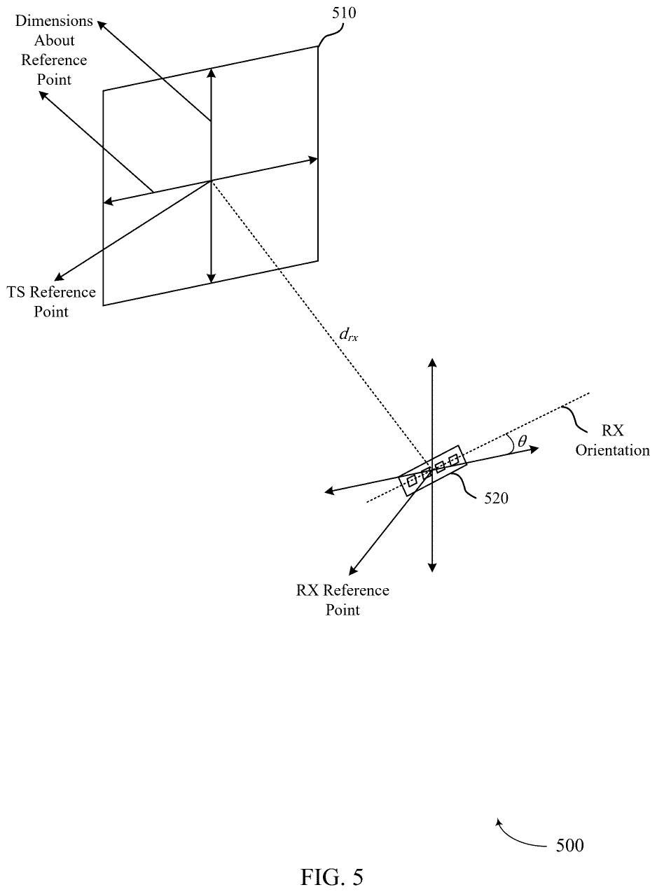

FIG. 5 shows an example of a TS orientation diagram 500 that supports communications via TSs using different beams for uplink and downlink in accordance with one or more aspects of the present disclosure. The TS orientation diagram 500 may implement or may be implemented by aspects of the wireless communications system 100, the TS signaling diagram 200, the TS signaling diagram 300, or the wireless communications system 400.

As described herein, a network entity 105 may configure multiple multi-port CSI-RS resource sets that each target a specific TS (e.g., the TS 410-a and the TS 410-b of FIG. 4). The network entity 105 may configure L≥1 CSI-RS ports. For far-field scenarios, the network entity 105 may create L beams based on direction information (e.g., by creating narrow beams pointing in a narrow field of view about a selected reference direction). For near field, the spherical curvature of wave-front may be considered, which may use distance information.

For example, for downlink signaling, as described herein, the cascade channel TX-TS-RX may be given by HOG, where H may be a LOS MIMO channel from the TS to the UE 115, θ may be the TS pattern matrix, and G may be a LoS MIMO channel from the network entity 105 to the TS. To construct analog beams at the network entity for downlink signaling, letting G=USV* be the singular value decomposition (SVD) of the network entity 105 to TS channel, the columns of V may be well-matched beams for the cascade channel HθG. The network entity 105 may approximately obtain V if the network entity 105 can approximately determine the LoS MIMO channel to the TS:G. Similar observations may apply to the UE end, where the UE 115 may approximately determine the LoS MIMO channel H.

As shown in FIG. 5, for a TS 510, a TS reference point may be at a center of the TS 510, a receiving antenna array 520 (for the UE 115 in downlink or the network entity 105 in uplink) may have a receiving antenna array reference point at a center of the receiving antenna array 520, a distance dᵣₓ may correspond to the distance between the receiving antenna array reference point and the TS reference point, and an angle θ may indicate an orientation or tilt of the receiving antenna array 520 with respect to the horizontal of the TS 510.

In some examples, the network entity 105 and UE 115 may exchange parameters for TS specific beamforming and/or a codebook with at least one of: (i) TS reference point coordinates with respect to a coordinate-system (CS) known to network entity 105 or UE 115; or with respect to a Global CS and associated translation information (ii) TS dimensions about reference point for planar TS (and/or additional geometry information such as curvature for conformal TS); or (iii) distance from network entity 105 antenna array reference point to TS reference point. In some examples, the network entity 105 and UE 115 may exchange one or more of: (a) TS unit-cell spacing; (b) applied TS pattern; (c) target receiver reference element coordinates in known CS or GCS with translation info; (d) target receiver array/aperture dimensions; or (e) target receiver orientation (e.g., θ).

In some examples, TS specific analog beamforming sets of vectors may be determined by a network node for a network entity 105 or UE 115 and may be downloaded by the network entity 105 or UE 115 from the network node (e.g., based on the relative positions of the TS and the UE 115 or network entity 105).

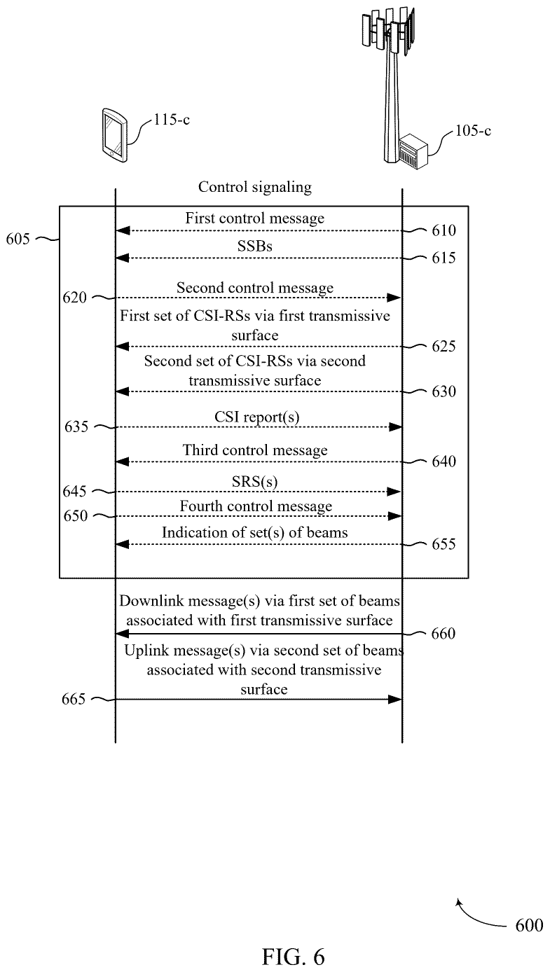

FIG. 6 shows an example of a process flow 600 that supports communications via TSs using different beams for uplink and downlink in accordance with one or more aspects of the present disclosure. The process flow 600 may implement or may be implemented by aspects of the wireless communications system 100, the TS signaling diagram 200, the TS signaling diagram 300, or the wireless communications system 400. For example, the process flow 600 may include a UE 115-c, which may be an example of a UE 115 as described herein. The process flow 600 may also include a network entity 105-c, which may be an example of a network entity 105 as described herein. In the following description of the process flow 600, the communications between the network entity 105-c and the UE 115-c may be transmitted in a different order than the example order shown, or the operations performed by the network entity 105-c and the UE 115-c may be performed in different orders or at different times. Some operations may also be omitted from the process flow 600, and other operations may be added to the process flow 600.

At 605, the UE 115-c and the network entity 105-c may communicate control signaling associated with downlink beamforming via a first TS between the UE 115-c and the network entity 105-c and associated with uplink beamforming via a second TS between the UE 115-c and the network entity 105-c.

At 660, the UE 115-c may receive, via a first set of beams associated with the first TS, one or more downlink messages based on the control signaling at 605. The network entity 105-c may transmit the one or more downlink messages via a first set of network-side beams.

At 665, the UE 115-c may transmit, via a second set of beams associated with the second TS, one or more uplink messages based on the control signaling at 605. The first set of beams may be different from the second set of beams, and the first TS may be different from the second TS. The network entity 105-c may receive the one or more uplink messages via a second set of network-side beams that are different from the first set of network-side beams. In some examples, the one or more downlink messages may be multi-layer (e.g., rank-2 or above) transmissions, and the one or more uplink messages may be single-layer (e.g., rank-1) transmissions. For example, the first TS may be more beneficial for multi-layer transmissions, and the second TS may be more beneficial for single-layer transmissions.

In some examples, communication of the control signaling at 605 may involve, at 610, transmission by the network entity 105-c to the UE 115-c of a first control message that indicates a triggering condition associated with communication using different sets of beams for uplink and downlink that are associated with different TSs between the UE 115-c and the network entity 105-c. For example, the network entity 105-c may configure the UE 115-c with the triggering condition based on side-information, such as: a UE 115-c location estimate, data-rate logs from the UE 115-c or other UEs 115 in similar locations (e.g., determined as being similar locations based on beams used to communicate with the UE 115-c and the other UEs 115); or an accessible database about the facility in which the UE is located including constituent TS information.

In some such examples, communication of the control signaling at 605 may involve, at 620, transmission by the UE 115-c to the network entity 105-c of a second control message that indicates satisfaction of the triggering condition. In some examples, at 615, the network entity 105-b may transmit a set of SSBs via the first TS and the second TS, and satisfaction of the triggering condition indicated in the second control message at 620 may be based on reception of the set of SSBs. For example, after being configured with the triggering condition by the first control message at 610, the UE 115-c may detect the set of SSBs using multiple receive beams (possibly across different panels or antenna modules of the UE 115-c). The second control message at 620 may indicate whether or if the UE 115-a determines that separate uplink and downlink beams may be beneficial (e.g., based on the triggering condition indicated in the first control message at 610). In some examples, the first control message at 610 may indicate a time-frequency resource for the UE to use to transmit the second control message (e.g., using a beam corresponding to the strongest RSRP from the set of SSBs).

In some examples, the triggering condition may be multiple receive beams having a respective RSRP above a threshold for the reception of the set of SSBs, which may indicate distinct paths, each offering a useful signal gain. For example, the satisfaction of the triggering condition may be that a first SSB of the set of SSBs received via the first TS and a second SSB of the set of SSBs received via the second TS each exceed a threshold measurement value (e.g., RSRP measurement value). In some examples, the RSRP threshold may be configured by the network entity 105-c. In some examples, the UE 115-c may receive a first subset of the set of SSBs at 615 via a first receive beam associated with a first TS and the UE 115-c may receive a second subset of the set of SSBs at 615 via a second receive beam associated with the second TS. In some examples, the UE 115-c may receive each of the set of SSBs at 615 via a first receive beam associated with the first TS and the UE 115-c may receive each of the set of SSBs at 615 via a second receive beam associated with the second TS. In some examples, the UE 115-c may receive one SSB from the set of SSBs at 615 via a first receive beam associated with the first TS and the UE 115-c may receive the same SSB from the set of SSBs at 615 via a second receive beam associated with the second TS. In such examples, the same SSB received via the different receive beams satisfying the RSRP threshold via both receive beams may satisfy the triggering condition. In some examples, different indexed SSBs received via the two different TSs (via different receive beams at the UE 115-c) satisfying the RSRP threshold via both receive beams may satisfy the triggering condition. In some examples, the triggering condition may be positioning information of the UE 115-c within a building or vehicle that includes the first TS and the second TS. For example, the UE 115-c may be configured to indicate via the second control message at 620 that the UE 115-c is located within a building or vehicle that includes multiple TSs.

In some examples, based on the indication of satisfaction of the triggering condition at 620, at 625 the network entity 105-c may transmit a first set of CSI-RSs that target the first TS, and at 630 the network entity 105-c may transmit a second set of CSI-RSs that target the second TS. The UE 115-c may receive the first set of CSI-RSs via the first TS, and the UE 115-c may receive the second set of CSI-RSs via the second TS. For example, the first set of CSI-RSs may be a first multi-port CSI-RS resource set with repetition, and the second set of CSI-RSs may be a second multi-port CSI-RS resource set with repetition. Each provisioned multi-port CSI-RS resource set may be quasi co-located (QCL′ed) with an SSB from the set of SSBs transmitted at 615 and reported by the UE 115-c (for example, in the second control message at 620). Based on the CSI-RSs at 625 and 630, communication of the control signaling at 605 may include transmission by the UE 115-c at 635 of one or more CSI reports. In some examples, the first set of beams and the second set of beams used at 660 and 665 may be based on the one or more CSI reports. In some examples, the one or more CSI reports at 635 may indicate a selection of a downlink resource set based on the first set of CSI-RSs, and/or the one or more CSI reports at 635 may indicate a selection of an uplink resource set based on the second set of CSI-RSs. The downlink resource set may indicate which transmit beams for the network entity 105-c to use for downlink signaling, and the uplink resource set may indicate which receive beam for the network entity 105-c to use for uplink signaling. In some examples, the one or more CSI reports at 635 may indicate uplink metrics based on the second set of CSI-RSs, and the network entity 105-c may transmit a third control message at 640 that indicates a selected uplink resource set (that indicates the set of beams for uplink at 665) based on the uplink metrics indicated in the one or more CSI reports.

In some examples, communication of the control signaling at 605 may involve, at 640, reception by the UE 115-c from the network entity 105-c of a third control message that schedules a set of SRSs based on the one or more CSI reports. For example, SRSs may be avoided, and thus power saved at the UE 115-c if the uplink metrics satisfy a measurement threshold (e.g., if CSI-RSs of the second set of CSI-RSs satisfy an RSRP threshold). In some examples, the network entity 105-c may schedule SRSs if the threshold is not met and/or if the network entity 105-c identifies a discrepancy in the uplink metrics reported in one or more CSI reports, and at 645 the UE 115-c may transmit the SRSs scheduled by the third control message. In such examples, at 655, communication of the control signaling at 605 may involve transmission by the network entity 105-c of an indication of a set of beams to use for uplink (e.g., the second set of beams) based on measurements of the SRSs.

In some examples, communication of the control signaling at 605 may involve, at 640, reception by the UE 115-c from the network entity 105-c of a third control message that requests one or more uplink transmission metrics based on the one or more CSI reports. For example, the network entity 105-b may request a power headroom report or any applied maximum permissible exposure (MPE) assumption and/or may verify the UE uplink resource set preference. In such examples, communication of the control signaling at 605 may involve, at 650, transmission by the UE 115-c to the network entity 105-c of a fourth control message that indicates the one or more uplink transmission metrics. In such examples, at 655, communication of the control signaling at 605 may involve transmission by the network entity 105-c of an indication of a set of beams to use for uplink (e.g., the second set of beams) based on the fourth control message.

In some examples, communication of the control signaling at 605 may involve, at 640, reception by the UE 115-c from the network entity 105-c of a third control message, based on the one or more CSI reports, that indicates one or more uplink transmission power or path loss offset metrics, and the one or more uplink messages at 665 may be transmitted in accordance with the one or more uplink transmission power or path loss offset metrics. For example, the network entity 105-c may indicate a reciprocity-confirmation warning, where additional measures such as active window tinting can break reciprocity between the CSI-RSs and the uplink beams. Accordingly the network entity 105-c may modify and may indicate the power (e.g., path-loss offset) the UE should use for uplink metric computation based on downlink measurements of the second set of CSI-RSs.

In some examples, the first set of CSI-RSs at 625 and the second set of CSI-RSs at 630 may be based on: first relative positioning between the UE 115-c and the first TS; a second relative positioning between the UE 115-c and the second TS; a third relative positioning between the network entity 105-c and the first TS; a fourth relative positioning between the network entity 105-c and the second TS; geometric information of the first TS; geometric information of the second TS; or any combination thereof.

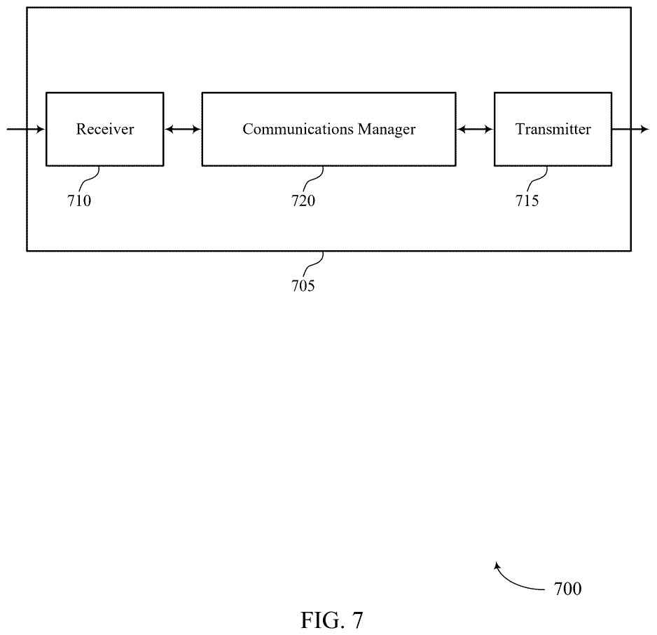

FIG. 7 shows a block diagram 700 of a device 705 that supports communications via TSs using different beams for uplink and downlink in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to communications via TSs using different beams for uplink and downlink). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to communications via TSs using different beams for uplink and downlink). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of communications via TSs using different beams for uplink and downlink as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for communicating, with a network entity, control signaling associated with downlink beamforming via a first TS between the UE and the network entity, where the control signaling is further associated with uplink beamforming via a second TS between the UE and the network entity. The communications manager 720 is capable of, configured to, or operable to support a means for receiving, via a first set of beams associated with the first TS, one or more downlink messages based on the control signaling. The communications manager 720 is capable of, configured to, or operable to support a means for transmitting, via a second set of beams associated with the second TS, one or more uplink messages based on the control signaling, where the first set of beams are different from the second set of beams, and where the first TS is different from the second TS.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficient utilization of communication resources.

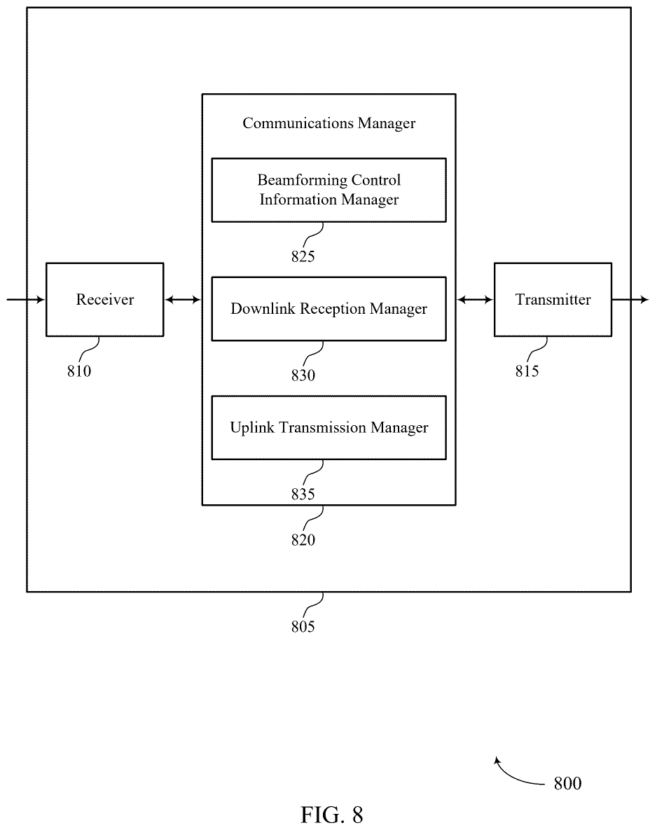

FIG. 8 shows a block diagram 800 of a device 805 that supports communications via TSs using different beams for uplink and downlink in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to communications via TSs using different beams for uplink and downlink). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to communications via TSs using different beams for uplink and downlink). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of communications via TSs using different beams for uplink and downlink as described herein. For example, the communications manager 820 may include a beamforming control information manager 825, a downlink reception manager 830, an uplink transmission manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The beamforming control information manager 825 is capable of, configured to, or operable to support a means for communicating, with a network entity, control signaling associated with downlink beamforming via a first TS between the UE and the network entity, where the control signaling is further associated with uplink beamforming via a second TS between the UE and the network entity. The downlink reception manager 830 is capable of, configured to, or operable to support a means for receiving, via a first set of beams associated with the first TS, one or more downlink messages based on the control signaling. The uplink transmission manager 835 is capable of, configured to, or operable to support a means for transmitting, via a second set of beams associated with the second TS, one or more uplink messages based on the control signaling, where the first set of beams are different from the second set of beams, and where the first TS is different from the second TS.

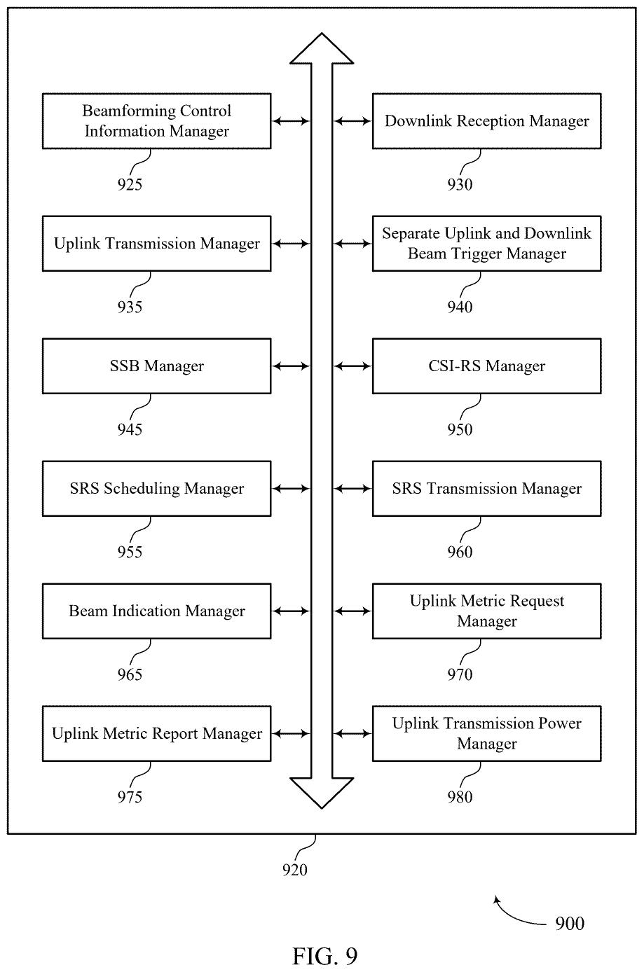

FIG. 9 shows a block diagram 900 of a communications manager 920 that supports communications via TSs using different beams for uplink and downlink in accordance with one or more aspects of the present disclosure. The communications manager 920 may be an example of aspects of a communications manager 720, a communications manager 820, or both, as described herein. The communications manager 920, or various components thereof, may be an example of means for performing various aspects of communications via TSs using different beams for uplink and downlink as described herein. For example, the communications manager 920 may include a beamforming control information manager 925, a downlink reception manager 930, an uplink transmission manager 935, a separate uplink and downlink beam trigger manager 940, an SSB manager 945, a CSI-RS manager 950, an SRS scheduling manager 955, an SRS transmission manager 960, a beam indication manager 965, an uplink metric request manager 970, an uplink metric report manager 975, an uplink transmission power manager 980, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The beamforming control information manager 925 is capable of, configured to, or operable to support a means for communicating, with a network entity, control signaling associated with downlink beamforming via a first TS between the UE and the network entity, where the control signaling is further associated with uplink beamforming via a second TS between the UE and the network entity. The downlink reception manager 930 is capable of, configured to, or operable to support a means for receiving, via a first set of beams associated with the first TS, one or more downlink messages based on the control signaling. The uplink transmission manager 935 is capable of, configured to, or operable to support a means for transmitting, via a second set of beams associated with the second TS, one or more uplink messages based on the control signaling, where the first set of beams are different from the second set of beams, and where the first TS is different from the second TS.

In some examples, to support communicating the control signaling, the separate uplink and downlink beam trigger manager 940 is capable of, configured to, or operable to support a means for receiving, from the network entity, a first control message that indicates a triggering condition associated with communication using different sets of beams for uplink and downlink that are associated with different TSs between the UE and the network entity. In some examples, to support communicating the control signaling, the separate uplink and downlink beam trigger manager 940 is capable of, configured to, or operable to support a means for transmitting, to the network entity, a second control message that indicates satisfaction of the triggering condition, where reception of the one or more downlink messages via the first set of beams and transmission of the one or more uplink messages via the second set of beams is based on the second control message.

In some examples, the SSB manager 945 is capable of, configured to, or operable to support a means for receiving a set of SSBs via the first TS and the second TS, and where the satisfaction of the triggering condition is based on reception of the set of SSBs.

In some examples, to support receiving the set of SSBs, the SSB manager 945 is capable of, configured to, or operable to support a means for receiving a first subset of the set of SSBs via a first receive beam associated with the first TS. In some examples, to support receiving the set of SSBs, the SSB manager 945 is capable of, configured to, or operable to support a means for receiving a second subset of the set of SSBs via a second receive beam associated with the second TS.

In some examples, to support receiving the set of SSBs, the SSB manager 945 is capable of, configured to, or operable to support a means for receiving each of the set of SSBs via a first receive beam associated with the first TS. In some examples, to support receiving the set of SSBs, the SSB manager 945 is capable of, configured to, or operable to support a means for receiving each of the set of SSBs via a second receive beam associated with the second TS.

In some examples, the satisfaction of the triggering condition includes a first SSB of the set of SSBs received via the first TS and a second SSB of the set of SSBs received via the second TS each exceeding a threshold measurement value. In some examples, the first SSB and the second SSB may be the same SSB received via different receive beams at the UE. In some examples, the first SSB and the second SSB may be different SSBs.

In some examples, the triggering condition includes positioning information of the UE within a building or vehicle that includes the first TS and the second TS.

In some examples, the CSI-RS manager 950 is capable of, configured to, or operable to support a means for receiving, based on the second control message, a first set of CSI-RSs via the first TS. In some examples, the CSI-RS manager 950 is capable of, configured to, or operable to support a means for receiving, based on the second control message, a second set of CSI-RSs via the second TS, and where communicating the control signaling includes transmitting one or more CSI reports based on the first set of CSI-RSs and the second set of CSI-RSs, where the first set of beams and the second set of beams are based on the one or more CSI reports.

In some examples, the one or more CSI reports indicate a first selection of a downlink resource set based on the first set of CSI-RSs. In some examples, the first set of beams are based on the first selection of the downlink resource set. In some examples, the one or more CSI reports indicate a second selection of an uplink resource set based on the second set of CSI-RSs. In some examples, the second set of beams are based on the second selection of the uplink resource set.

In some examples, to support communicating the control signaling, the SRS scheduling manager 955 is capable of, configured to, or operable to support a means for receiving, from the network entity and based on the one or more CSI reports, a third control message that schedules a set of sounding reference signals. In some examples, to support communicating the control signaling, the SRS transmission manager 960 is capable of, configured to, or operable to support a means for transmitting, in accordance with the third control message, the set of sounding reference signals. In some examples, to support communicating the control signaling, the beam indication manager 965 is capable of, configured to, or operable to support a means for receiving, from the network entity and based on the set of sounding reference signals, an indication of the second set of beams.

In some examples, to support communicating the control signaling, the uplink metric request manager 970 is capable of, configured to, or operable to support a means for receiving, from the network entity and based on the one or more CSI reports, a third control message that requests one or more uplink transmission metrics. In some examples, to support communicating the control signaling, the uplink metric report manager 975 is capable of, configured to, or operable to support a means for transmitting, to the network entity, a fourth control message that indicates the one or more uplink transmission metrics. In some examples, to support communicating the control signaling, the beam indication manager 965 is capable of, configured to, or operable to support a means for receiving, from the network entity and based on the fourth control message, an indication of the second set of beams.

In some examples, the uplink transmission power manager 980 is capable of, configured to, or operable to support a means for receiving, from the network entity and based on the one or more CSI reports, a third control message that indicates one or more uplink transmission power or path loss offset metrics, where the one or more uplink messages are transmitted in accordance with the one or more uplink transmission power or path loss offset metrics.

In some examples, the first set of CSI-RSs and the second set of CSI-RSs are based on: a first relative positioning between the UE and the first TS; a second relative positioning between the UE and the second TS; a third relative positioning between the network entity and the first TS, where the first set of CSI-RSs and the second set of CSI-RSs are received via the network entity; a fourth relative positioning between the network entity and the second TS; geometric information of the first TS; geometric information of the second TS; or any combination thereof.

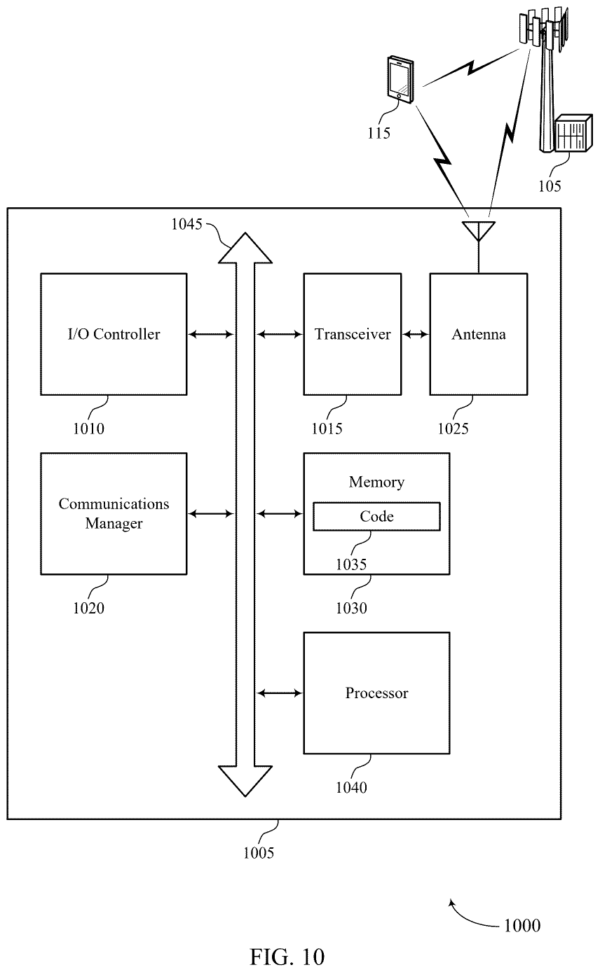

FIG. 10 shows a diagram of a system 1000 including a device 1005 that supports communications via TSs using different beams for uplink and downlink in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting communications via TSs using different beams for uplink and downlink). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for communicating, with a network entity, control signaling associated with downlink beamforming via a first TS between the UE and the network entity, where the control signaling is further associated with uplink beamforming via a second TS between the UE and the network entity. The communications manager 1020 is capable of, configured to, or operable to support a means for receiving, via a first set of beams associated with the first TS, one or more downlink messages based on the control signaling. The communications manager 1020 is capable of, configured to, or operable to support a means for transmitting, via a second set of beams associated with the second TS, one or more uplink messages based on the control signaling, where the first set of beams are different from the second set of beams, and where the first TS is different from the second TS.

By including or configuring the communications manager 1020 in accordance with examples as described herein, the device 1005 may support techniques for improved communication reliability, reduced latency, improved user experience related to reduced processing, more efficient utilization of communication resources, improved coordination between devices.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of communications via TSs using different beams for uplink and downlink as described herein, or the at least one processor 1040 and the at least one memory 1030 may be otherwise configured to, individually or collectively, perform or support such operations.

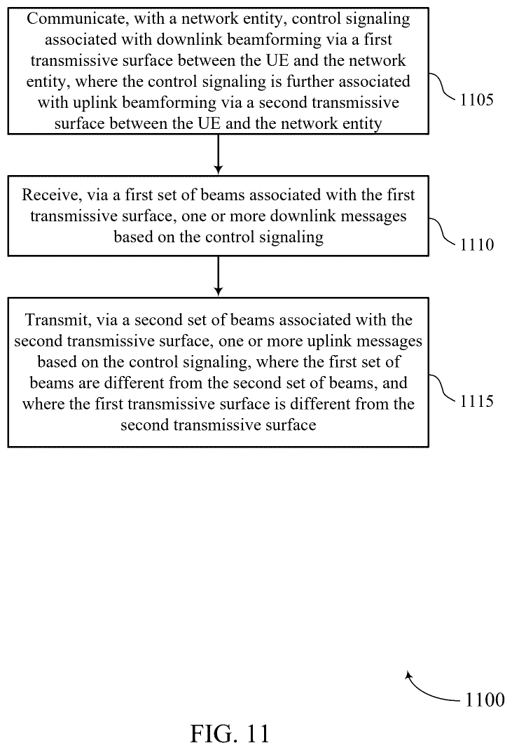

FIG. 11 shows a flowchart illustrating a method 1100 that supports communications via TSs using different beams for uplink and downlink in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include communicating, with a network entity, control signaling associated with downlink beamforming via a first transmissive surface (TS) between the UE and the network entity, where the control signaling is further associated with uplink beamforming via a second TS between the UE and the network entity. The operations of 1105 may be performed in accordance with examples as disclosed herein, such as in accordance with the communication of the control signaling at 605 of FIG. 6. In some examples, aspects of the operations of 1105 may be performed by a beamforming control information manager 925 as described with reference to FIG. 9. Additionally, or alternatively, aspects of the operations of 1105 may be performed by the device 1005 in association with the at least one processor 1040 executing the code 1035 stored in the at least one memory 1030, as described with reference to FIG. 10.

At 1110, the method may include receiving, via a first set of beams associated with the first TS, one or more downlink messages based on the control signaling. The operations of 1110 may be performed in accordance with examples as disclosed herein, such as in accordance with reception of the one or more downlink messages at 660 of FIG. 6. In some examples, aspects of the operations of 1110 may be performed by a downlink reception manager 930 as described with reference to FIG. 9. Additionally, or alternatively, aspects of the operations of 1110 may be performed by the device 1005 in association with the at least one processor 1040 executing the code 1035 stored in the at least one memory 1030, as described with reference to FIG. 10.

At 1115, the method may include transmitting, via a second set of beams associated with the second TS, one or more uplink messages based on the control signaling, where the first set of beams are different from the second set of beams, and where the first TS is different from the second TS. The operations of 1115 may be performed in accordance with examples as disclosed herein, such as in accordance with transmission of the one or more uplink messages at 665 of FIG. 6. In some examples, aspects of the operations of 1115 may be performed by an uplink transmission manager 935 as described with reference to FIG. 9. Additionally, or alternatively, aspects of the operations of 1110 may be performed by the device 1005 in association with the at least one processor 1040 executing the code 1035 stored in the at least one memory 1030, as described with reference to FIG. 10.

The following provides an overview of aspects of the present disclosure:
Aspect 1: A method for wireless communications at a UE, comprising: communicating, with a network entity, control signaling associated with downlink beamforming via a first TS between the UE and the network entity, wherein the control signaling is further associated with uplink beamforming via a second TS between the UE and the network entity; receiving, via a first set of beams associated with the first TS, one or more downlink messages based at least in part on the control signaling; and transmitting, via a second set of beams associated with the second TS, one or more uplink messages based at least in part on the control signaling, wherein the first set of beams are different from the second set of beams, and wherein the first TS is different from the second TS.
Aspect 2: The method of aspect 1, wherein communicating the control signaling further comprises: receiving, from the network entity, a first control message that indicates a triggering condition associated with communication using different sets of beams for uplink and downlink that are associated with different TSs between the UE and the network entity; and transmitting, to the network entity, a second control message that indicates satisfaction of the triggering condition, wherein reception of the one or more downlink messages via the first set of beams and transmission of the one or more uplink messages via the second set of beams is based at least in part on the second control message.
Aspect 3: The method of aspect 2, further comprising: receiving a set of SSBs via the first TS and the second TS, and wherein the satisfaction of the triggering condition is based at least in part on reception of the set of SSBs.
Aspect 4: The method of aspect 3, wherein receiving the set of SSBs comprises: receiving a first subset of the set of SSBs via a first receive beam associated with the first TS; and receiving a second subset of the set of SSBs via a second receive beam associated with the second TS.
Aspect 5: The method of aspect 3, wherein receiving the set of SSBs comprises: receiving each of the set of SSBs via a first receive beam associated with the first TS; and receiving each of the set of SSBs via a second receive beam associated with the second TS.
Aspect 6: The method of any of aspects 3 through 5, wherein the satisfaction of the triggering condition comprises a first SSB of the set of SSBs received via the first TS and a second SSB of the set of SSBs received via the second TS each exceeding a threshold measurement value.
Aspect 7: The method of any of aspects 2 through 6, wherein the triggering condition comprises positioning information of the UE within a building or vehicle that comprises the first TS and the second TS.
Aspect 8: The method of any of aspects 2 through 7, further comprising: receiving, based at least in part on the second control message, a first set of CSI-RSs via the first TS; and receiving, based at least in part on the second control message, a second set of CSI-RSs via the second TS, and wherein communicating the control signaling comprises transmitting one or more CSI reports based at least in part on the first set of CSI-RSs and the second set of CSI-RSs, wherein the first set of beams and the second set of beams are based at least in part on the one or more CSI reports.
Aspect 9: The method of aspect 8, wherein the one or more CSI reports indicate a first selection of a downlink resource set based at least in part on the first set of CSI-RSs, the first set of beams are based at least in part on the first selection of the downlink resource set, the one or more CSI reports indicate a second selection of an uplink resource set based at least in part on the second set of CSI-RSs, and the second set of beams are based at least in part on the second selection of the uplink resource set.
Aspect 10: The method of any of aspects 8 through 9, wherein communicating the control signaling further comprises: receiving, from the network entity and based at least in part on the one or more CSI reports, a third control message that schedules a set of SRSs; transmitting, in accordance with the third control message, the set of SRSs; and receiving, from the network entity and based at least in part on the set of SRSs, an indication of the second set of beams.
Aspect 11: The method of any of aspects 8 through 10, wherein communicating the control signaling further comprises: receiving, from the network entity and based at least in part on the one or more CSI reports, a third control message that requests one or more uplink transmission metrics; transmitting, to the network entity, a fourth control message that indicates the one or more uplink transmission metrics; and receiving, from the network entity and based at least in part on the fourth control message, an indication of the second set of beams.
Aspect 12: The method of any of aspects 8 through 11, further comprising: receiving, from the network entity and based at least in part on the one or more CSI reports, a third control message that indicates one or more uplink transmission power or path loss offset metrics, wherein the one or more uplink messages are transmitted in accordance with the one or more uplink transmission power or path loss offset metrics.
Aspect 13: The method of any of aspects 8 through 12, wherein the first set of CSI-RSs and the second set of CSI-RSs are based at least in part on a first relative positioning between the UE and the first TS; a second relative positioning between the UE and the second TS; a third relative positioning between the network entity and the first TS, wherein the first set of CSI-RSs and the second set of CSI-RSs are received via the network entity; a fourth relative positioning between the network entity and the second TS; geometric information of the first TS; geometric information of the second TS; or any combination thereof.
Aspect 14: A UE for wireless communications, comprising a processing system that includes processor circuitry and memory circuitry that stores code, the processing system configured to cause the UE to perform a method of any of aspects 1 through 13.
Aspect 15: A UE for wireless communications, comprising at least one means for performing a method of any of aspects 1 through 13.
Aspect 16: A non-transitory computer-readable medium storing code for wireless communications, the code comprising instructions executable by one or more processors to perform a method of any of aspects 1 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.” Also, as used herein, the phrase “a set” shall be construed as including the possibility of a set with one member. That is, the phrase “a set” shall be construed in the same manner as “one or more” or “at least one of.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
communicate, with a network entity, control signaling associated with downlink beamforming via a first transmissive surface between the UE and the network entity, wherein the control signaling is further associated with uplink beamforming via a second transmissive surface between the UE and the network entity;
receive, via a first set of beams associated with the first transmissive surface, one or more downlink messages based at least in part on the control signaling; and
transmit, via a second set of beams associated with the second transmissive surface, one or more uplink messages based at least in part on the control signaling, wherein the first set of beams are different from the second set of beams, and wherein the first transmissive surface is different from the second transmissive surface.

2. The UE of claim 1, wherein, to communicate the control signaling, the one or more processors are individually or collectively further operable to execute the code to cause the UE to:
receive, from the network entity, a first control message that indicates a triggering condition associated with communication using different sets of beams for uplink and downlink that are associated with different transmissive surfaces between the UE and the network entity; and
transmit, to the network entity, a second control message that indicates satisfaction of the triggering condition, wherein reception of the one or more downlink messages via the first set of beams and transmission of the one or more uplink messages via the second set of beams is based at least in part on the second control message.

3. The UE of claim 2, wherein the one or more processors are individually or collectively further operable to execute the code to cause the UE to:
receive a set of synchronization signal blocks via the first transmissive surface and the second transmissive surface, and wherein the satisfaction of the triggering condition is based at least in part on reception of the set of synchronization signal blocks.

4. The UE of claim 3, wherein, to receive the set of synchronization signal blocks, the one or more processors are individually or collectively operable to execute the code to cause the UE to:
receive a first subset of the set of synchronization signal blocks via a first receive beam associated with the first transmissive surface; and
receive a second subset of the set of synchronization signal blocks via a second receive beam associated with the second transmissive surface.

5. The UE of claim 3, wherein, to receive the set of synchronization signal blocks, the one or more processors are individually or collectively operable to execute the code to cause the UE to:
receive each of the set of synchronization signal blocks via a first receive beam associated with the first transmissive surface; and
receive each of the set of synchronization signal blocks via a second receive beam associated with the second transmissive surface.

6. The UE of claim 3, wherein the satisfaction of the triggering condition comprises a first synchronization signal block of the set of synchronization signal blocks received via the first transmissive surface and a second synchronization signal block of the set of synchronization signal blocks received via the second transmissive surface each exceeding a threshold measurement value.

7. The UE of claim 2, wherein the triggering condition comprises positioning information of the UE within a building or vehicle that comprises the first transmissive surface and the second transmissive surface.

8. The UE of claim 2, wherein the one or more processors are individually or collectively further operable to execute the code to cause the UE to:
receive, based at least in part on the second control message, a first set of channel state information reference signals via the first transmissive surface; and
receive, based at least in part on the second control message, a second set of channel state information reference signals via the second transmissive surface, and wherein communicating the control signaling comprises transmitting one or more channel state information reports based at least in part on the first set of channel state information reference signals and the second set of channel state information reference signals, wherein the first set of beams and the second set of beams are based at least in part on the one or more channel state information reports.

9. The UE of claim 8, wherein:
the one or more channel state information reports indicate a first selection of a downlink resource set based at least in part on the first set of channel state information reference signals,
the first set of beams are based at least in part on the first selection of the downlink resource set,
the one or more channel state information reports indicate a second selection of an uplink resource set based at least in part on the second set of channel state information reference signals, and
the second set of beams are based at least in part on the second selection of the uplink resource set.

10. The UE of claim 8, wherein, to communicate the control signaling, the one or more processors are individually or collectively further operable to execute the code to cause the UE to:
receive, from the network entity and based at least in part on the one or more channel state information reports, a third control message that schedules a set of sounding reference signals;
transmit, in accordance with the third control message, the set of sounding reference signals; and
receive, from the network entity and based at least in part on the set of sounding reference signals, an indication of the second set of beams.

11. The UE of claim 8, wherein, to communicate the control signaling, the one or more processors are individually or collectively further operable to execute the code to cause the UE to:
receive, from the network entity and based at least in part on the one or more channel state information reports, a third control message that requests one or more uplink transmission metrics;
transmit, to the network entity, a fourth control message that indicates the one or more uplink transmission metrics; and
receive, from the network entity and based at least in part on the fourth control message, an indication of the second set of beams.

12. The UE of claim 8, wherein the one or more processors are individually or collectively further operable to execute the code to cause the UE to:
receive, from the network entity and based at least in part on the one or more channel state information reports, a third control message that indicates one or more uplink transmission power or path loss offset metrics, wherein the one or more uplink messages are transmitted in accordance with the one or more uplink transmission power or path loss offset metrics.

13. The UE of claim 8, wherein the first set of channel state information reference signals and the second set of channel state information reference signals are based at least in part on:
a first relative positioning between the UE and the first transmissive surface;
a second relative positioning between the UE and the second transmissive surface;
a third relative positioning between the network entity and the first transmissive surface, wherein the first set of channel state information reference signals and the second set of channel state information reference signals are received via the network entity;
a fourth relative positioning between the network entity and the second transmissive surface;
geometric information of the first transmissive surface;
geometric information of the second transmissive surface; or
any combination thereof.

14. A method for wireless communications at a user equipment (UE), comprising:
communicating, with a network entity, control signaling associated with downlink beamforming via a first transmissive surface between the UE and the network entity, wherein the control signaling is further associated with uplink beamforming via a second transmissive surface between the UE and the network entity;
receiving, via a first set of beams associated with the first transmissive surface, one or more downlink messages based at least in part on the control signaling; and
transmitting, via a second set of beams associated with the second transmissive surface, one or more uplink messages based at least in part on the control signaling, wherein the first set of beams are different from the second set of beams, and wherein the first transmissive surface is different from the second transmissive surface.

15. The method of claim 14, wherein communicating the control signaling further comprises:
receiving, from the network entity, a first control message that indicates a triggering condition associated with communication using different sets of beams for uplink and downlink that are associated with different transmissive surfaces between the UE and the network entity; and
transmitting, to the network entity, a second control message that indicates satisfaction of the triggering condition, wherein reception of the one or more downlink messages via the first set of beams and transmission of the one or more uplink messages via the second set of beams is based at least in part on the second control message.

16. The method of claim 15, further comprising:
receiving a set of synchronization signal blocks via the first transmissive surface and the second transmissive surface, and wherein the satisfaction of the triggering condition is based at least in part on reception of the set of synchronization signal blocks.

17. The method of claim 16, wherein receiving the set of synchronization signal blocks comprises:
receiving a first subset of the set of synchronization signal blocks via a first receive beam associated with the first transmissive surface; and
receiving a second subset of the set of synchronization signal blocks via a second receive beam associated with the second transmissive surface.

18. The method of claim 16, wherein receiving the set of synchronization signal blocks comprises:
receiving each of the set of synchronization signal blocks via a first receive beam associated with the first transmissive surface; and
receiving each of the set of synchronization signal blocks via a second receive beam associated with the second transmissive surface.

19. The method of claim 16, wherein the satisfaction of the triggering condition comprises a first synchronization signal block of the set of synchronization signal blocks received via the first transmissive surface and a second synchronization signal block of the set of synchronization signal blocks received via the second transmissive surface each exceeding a threshold measurement value.

20. A non-transitory computer-readable medium storing code for wireless communications at a user equipment (UE), the code comprising instructions executable by one or more processors to:
communicate, with a network entity, control signaling associated with downlink beamforming via a first transmissive surface between the UE and the network entity, wherein the control signaling is further associated with uplink beamforming via a second transmissive surface between the UE and the network entity;
receive, via a first set of beams associated with the first transmissive surface, one or more downlink messages based at least in part on the control signaling; and
transmit, via a second set of beams associated with the second transmissive surface, one or more uplink messages based at least in part on the control signaling, wherein the first set of beams are different from the second set of beams, and wherein the first transmissive surface is different from the second transmissive surface.
